(19) United States
(12) Patent Application Publication
(10) Pub. No.: US 2009/0256803 A1
(43) Pub. Date: Oct. 15, 2009

(54) SYSTEM AND METHOD FOR PROVIDING SIMULATED MOUSE DRAG AND CLICK FUNCTIONS FOR AN ELECTRONIC DEVICE

(75) Inventors: CHING-SEN TSAI, Tu-Cheng (TW); MEI-TSU TSAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/261,042

(22) Filed: Oct. 30, 2008

(30) Foreign Application Priority Data
Apr. 11, 2008 (CN) 200810301100.2

(51) Int. Cl. G09G 5/08

(52) U.S. Cl. 345/157

(57) ABSTRACT

A system and method for providing simulated mouse drag and click functions for an electronic device having a display are provided. The system includes a detection module, a define module, and a control module. The detection module includes at least one sensor for providing a horizontal move signal and a vertical move signal respectively in accordance with a horizontal move and a vertical move of an object within a selected area around the at least one sensor. The define module is for defining a move ratio between the horizontal move of the object in the selected area and the horizontal move of a cursor on the display. The control module is for generating a drag signal basing on the horizontal move signal and the move ratio, and for generating a click signal basing on the vertical move signal to activate corresponding mouse drag or click functions.

### BACKGROUND

1. Field of the Invention

Embodiments of the present disclosure relate to simulated mouse functions, and more particularly to a system and method for providing simulated mouse drag and click functions for an electronic device.

2. Description of Related Art

Modern desktop computers provide users with user-input mechanisms that are well suited for the applications that run on these computers. For example, the desktop computers often use an external peripheral, such as a mouse, that allows the user to conveniently navigate through menus of an application, as well as allowing navigation between applications and selection of various choices via a “click and drag” manner.

In addition, keyboard devices have long provided a convenient interface for the input of characters. However, when performing typing, such as in word processing applications, with the keyboard devices, a common complaint from users is that the users have to switch from the keyboard devices to the mouse, for the most part, in terms of navigation and selection controls, thus results in a very inconvenient user input mechanism.

Accordingly, a method and a system for providing simulated mouse drag and click function for an electronic device are called for in order to overcome the limitations described.

### SUMMARY

A computing system for providing simulated mouse drag and click functions for an electronic device having a display. The system includes a detection module, a define module, and a control module. The detection module includes at least one sensor for providing a horizontal move signal and a vertical move signal respectively in accordance with a horizontal move and a vertical move of an object within a selected area around the at least one sensor. The define module is for defining a move ratio between the horizontal move of the object in the selected area and the horizontal move of a cursor on the display. The control module is for generating a drag signal basing on the horizontal move signal and the move ratio, and for generating a click signal basing on the vertical move signal to activate corresponding mouse drag or click functions.

Other advantages and novel features of the present system and method for providing simulated mouse drag and click function for an electronic device will become more apparent from the following detailed description of certain inventive embodiments when taken in conjunction with the accompanying drawings.

### BRIEF DESCRIPTION OF THE DRAWINGS

FIG. 1 is a block diagram of an embodiment of a system for providing simulated mouse drag and click function for an electronic device; and

FIG. 2 is a flowchart of an embodiment of a method for providing simulated mouse drag and click functions for an electronic device.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

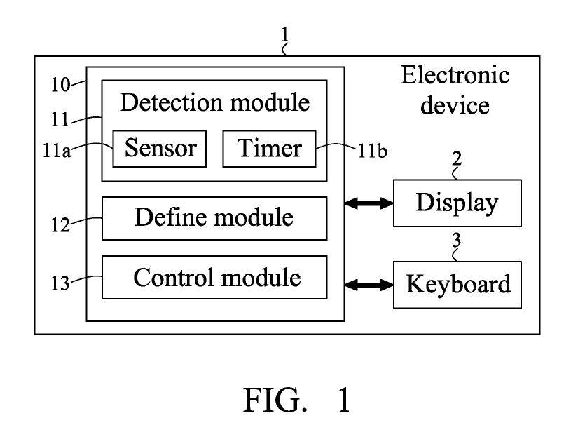

FIG. 1 is a block diagram of an embodiment of a system 10 for providing simulated mouse drag and click functions (hereinafter “the system 10”) for an electronic device 1 connected thereto. In one embodiment, the mouse drag function refers to changing a position of a cursor on a display 2 electronically coupled to the electronic device 1. In addition, the mouse click function includes a left-click function for activating a selected item and a right-click function for displaying a corresponding menu on the display 2, but the disclosure is not limited thereto.

The electronic device 1, such as a desktop computer, includes the display 2, a keyboard 3 having a plurality of keys arranged thereon, and the system 10 for providing simulated mouse drag and click functions for the electronic device 1. In other embodiments, the first electronic device 1 may be, a notebook computer, a server, or other device, without departing from the spirit of the disclosure.

In one embodiment, the system 10 includes a detection module 11, a define module 12 and a control module 13, in addition to other hardware and software components. The detection module 11 includes at least one sensor 11a and at least one corresponding timer 11b. The at least one sensor 11a is capable of detecting movement made by an object, such as a finger of a user, within a selected area around the at least one sensor 11a without being physically touched. Understandably, upon completion of the detection, the at least one sensor 11a calculates a X-axis distance, a Y-axis distance, and a Z-axis distance based on the distance of respective x-axis, y-axis and z-axis orientation. In order to increase the detecting precision, the move is determined to be the horizontal move if the Z-axis distance is smaller than a predefined value. Upon a condition that Z-axis distance is larger than the predefined value, the move is determined to be the vertical move.

In one embodiments, the at least one sensor 11a may be a component integrally formed with the keyboard 3. In alternative embodiments, the at least one sensor 11a may be an external component connected to the keyboard 3 by a standard Universal Serial Bus (USB) interface or a Bluetooth interface, but the disclosure is not limited thereto.

The timer 11b is activated upon detecting the move of the object within the selected area for counting a duration of the move. Thus, the detection module 11 is further configured for calculating a speed of the move basing on the duration and the distance thereof.

The detection module 11 is for providing a horizontal move signal upon detecting the horizontal move, and for providing a vertical move signal upon detecting the vertical move signal. It is to be noted that both the horizontal and the vertical move signals indicates the speed and the distance thereof.

The define module 12 is configured for defining a move ratio between the horizontal move of the object in the selected area and the horizontal move of the cursor on the display. For example, the cursor on the display moves 5 millimeters (mm) upon detecting the object moves 1 mms when the move ratio is 1:5. In addition, the define module 12 is also configured for defining a speed threshold and a distance threshold of the vertical move for determining an activation of a click function.

The control module 13 is configured for generating a drag signal basing on the horizontal move signal and the defined move ratio so as to activate corresponding mouse drag function. Using the above-mentioned example, upon receipt of the horizontal move signal indicating the speed and the distance thereof, the control module 13 generates a drag signal instructing the cursor on the display 2 to move based on the distance indicated by the horizontal move signal and the move ratio.

The control module 13 is also configured for generating a click signal based on the vertical move signal so as to activate corresponding mouse left-click function. The click signal is generated upon determining that the speed of the vertical move exceeds the speed threshold, and the distance of the vertical move exceeds the distance threshold. In addition, the control module 13 is also configured for generating a right-click signal upon receiving a signal indicating that a specific key of the keyboard 3 is pressed and the vertical move signal at the same time. The specific keys may include Ctrl, Alt, Shift, and Windows, but the disclosure is not limited thereto.

It is to be noted that in the embodiment, the click signal relates to mouse left-click function, such as activating the selected item. However, in alternative embodiments, the click signal may be directed to mouse right-click function.

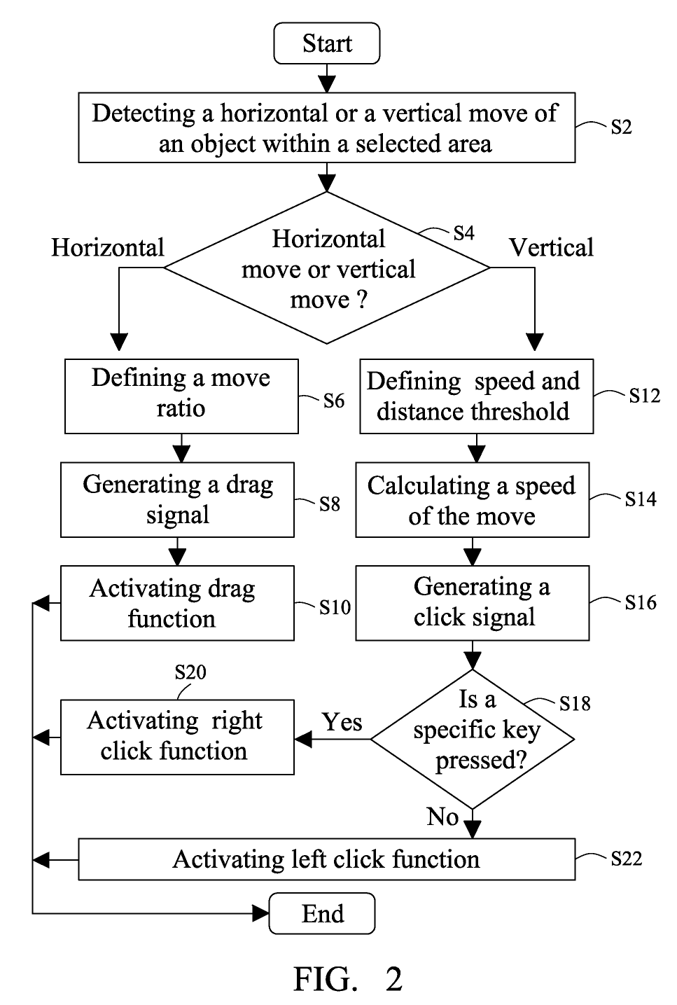

FIG. 2 is a flowchart of an embodiment of a method for providing simulated mouse drag and click functions for an electronic device. The method of FIG. 2 may used for detecting horizontal and vertical moves of an object within a selected area around the at least one sensor 11a so as to activate corresponding mouse drag and click functions. Depending on the embodiment, additional blocks may be added or deleted and the blocks may be executed in order other than that described.

In block S2, the detection module 11 detects a horizontal or a vertical move of an object within the selected area. In addition, the detection module 11 also activates the timer 11b upon detecting the vertical move for counting a duration of the move. In block S4, the detection module 11 provides a corresponding horizontal or vertical move signal.

If the provided signal relates to a horizontal move signal, in block S6, the define module 12 defines a move ratio between the horizontal move of the object in the selected area and the horizontal move of a cursor on the display 2. In block S8, the control module 13 generates the drag signal basing on the horizontal move signal and the move ratio. In block S10, the drag signal activates the mouse drag function.

If the provided signal relates to a vertical move signal, in block S12, the define module 12 defines a speed threshold and a distance threshold of the vertical move for determining an activation of the click function. In block S14, the detection module 11 calculates a speed of the vertical move basing on the duration and the distance of the vertical move. In block S16, the control module 13 generates the click signal upon determining that both of the speed and distance of the vertical move exceed the speed threshold and the distance threshold. In block S18, the control module 13 determines whether a specific key of the keyboard 3 is pressed.

If the specific key of the keyboard 3 is pressed, in block S20, the control module 13 generates a right click signal. Otherwise, in block S22, the control module 13 generates a left click signal.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for providing simulated mouse drag and click functions for an electronic device comprising a display, the system comprising:
a detection module comprising at least one sensor for providing a horizontal move signal and a vertical move signal respectively in accordance with a horizontal move and a vertical move of an object within a selected area around the at least one sensor;
a define module for defining a move ratio between the horizontal move of the object in the selected area and the horizontal move of a cursor on the display; and
a control module for generating a drag signal basing on the horizontal move signal and the move ratio, and for generating a click signal basing on the vertical move signal to activate corresponding mouse drag or click functions.

2. The system as claimed in claim 1, wherein the define module is further configured for defining a speed threshold and a distance threshold of the vertical move for determining an activation of the click function.

3. The system as claimed in claim 2, wherein the detection module further comprises a timer being activated upon detecting the vertical move of the object within the selected area for counting a duration of the vertical move, and the detection module is configured for calculating a speed of the vertical move basing on the duration and the distance of the vertical move.

4. The system as claimed in claim 3, wherein the click signal is generated upon determining that both of the speed and distance of the vertical move calculated by the detection module exceed the speed threshold and the distance threshold.

5. The system as claimed in claim 1, wherein the electronic device further comprises a keyboard comprises a plurality of keys, wherein the control module is further configured for generating a right click signal upon receiving a signal indicating that a specific key of the keyboard is pressed.

6. The system as claimed in claim 5, wherein the specific key is selected from the group consisting of: Ctrl, Alt, Shift, and Windows.

7. The system as claimed in claim 1, wherein the at least one sensor is integrally formed with the keyboard.

8. The system as claimed in claim 1, wherein the at least one sensor is an external component connected to the keyboard by an interface.

9. The system as claimed in claim 8, wherein the interface is a Bluetooth interface.

10. The system as claimed in claim 8, wherein the interface is a standard Universal Serial Bus (USB) interface.

11. A computer-implemented method for providing simulated mouse drag and click functions for an electronic device comprising a display, the method comprising:
providing a horizontal move signal or a vertical move signal by detecting a horizontal move or a vertical move of an object within a selected area around at least one sensor;
defining a move ratio between the horizontal move of the object in the selected area and the horizontal move of a cursor on the display; and
generating a drag signal basing on the horizontal move signal and the move ratio, and generating a click signal basing on the vertical move signal to activate corresponding mouse drag or click functions.

12. The method as claimed in claim 11, further comprising the step of defining a speed threshold and a distance threshold of the vertical move for determining an activation of the click function.

13. The method as claimed in claim 12, further comprising the step of:
activating a timer upon detecting the vertical move of the object within the selected area for counting a duration of the vertical move; and
calculating a speed of the vertical move basing on the duration and the distance of the vertical move.

14. The method as claimed in claim 13, further comprising the step of generating the click signal upon determining that both of the speed and distance of the vertical move exceed the speed threshold and the distance threshold.

15. The method as claimed in claim 11, further comprising the step of generating a right click signal upon receiving a signal indicating that a specific key of a keyboard of the electronic device is pressed.

16. The method as claimed in claim 15, wherein the specific key is selected from the group consisting of: Ctrl, Alt, Shift, and Windows.

17. The method as claimed in claim 15, further comprising the step of connecting the at least one sensor to the keyboard by an interface.

18. The system as claimed in claim 17, wherein the interface is a Bluetooth interface.

19. The system as claimed in claim 17, wherein the interface is a standard Universal Serial Bus (USB) interface.
